(19) United States
(12) Patent Application Publication
(10) Pub. No.: US 2006/0039638 A1
(43) Pub. Date: Feb. 23, 2006

(54) Sintered oil-impregnated bearing and manufacturing method thereof

(76) Inventors: Michiaki Takizawa, Nagano (JP); Hisaya Nakagawa, Nagano (JP); Tohru Nakanishi, Nagano (JP); Takeshi Kaneko, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/208,249

(22) Filed: Aug. 19, 2005

(30) Foreign Application Priority Data
Aug. 19, 2004 (JP) 2004-239115

(51) Int. Cl. F16C 33/02

(52) U.S. Cl. 384/279

(57) ABSTRACT

The disclosed invention provides a sintered oil-impregnated bearing equipped with a bearing hole having a clearance structure, in which a clearer boundary is formed between the bearing surface and the clearance surface, and a manufacturing method thereof. In a bearing hole of a radial bearing, a bearing surface and another bearing surface are formed at both ends in an axial direction, and a clearance surface is formed between both the bearing surface and the bearing surface. The bearing surfaces are formed by a sizing step for a compression-molded piece that is formed by a compression molding step. In the sizing step, diameter-reduction manufacturing is carried out for an end of the compression-molded piece to form a diameter-reduced section, and then afterward, a sizing core is inserted into the bearing hole of the compression-molded piece so as to eventually form the bearing surface.

### CROSS-REFERENCE TO RELATED APPLICATION

This application claims priority of Japanese Application No. 2004-239115, filed Aug. 19, 2004, the complete disclosure of which is hereby incorporated by reference.

### BACKGROUND OF THE INVENTION

a) Field of the Invention

The present invention relates to a sintered oil-impregnated bearing formed with a sintered alloy and a manufacturing method thereof. Further more in detail, the present invention relates to a sintered oil-impregnated bearing equipped with a bearing surface formed at each of both ends in an axial direction, and a clearance surface section having its inner diameter enlarged is formed between both the bearing surfaces to provide a bearing hole thereof with a clearance structure; and a manufacturing method thereof.

b) Description of the Related Art

As a radial bearing of a motor for audiovisual equipment and a motor for information-technology-related equipment, an inexpensive sintered oil-impregnated bearing is popularly used. Furthermore, in the case of motors for audiovisual equipment and so on, a structure in which two bearing surfaces are placed distantly from each other in their axial direction is adopted to support the rotary shaft in their radial direction for the purpose of prevention of a runout of the rotary shaft. Therefore, as a sintered oil-impregnated bearing of motors for audiovisual equipment and so on; a sintered oil-impregnated bearing, in which bearing surfaces are formed at both ends in an axial direction and a clearance surface section having its inner diameter enlarged is formed between both the bearing surfaces to provide a bearing hole thereof with a clearance structure, is used so as to reduce turning loss of the motor while the coaxiality between the two bearing surfaces being maintained.

Though sintered oil-impregnated bearings of this kind are manufactured by a process of cutting or metal molding, manufacturing by metal molding is widely adopted because of a problem of disposing of cut chips, which are generated in cutting work, as well as manufacturing cost. In particular, as a method of manufacturing a sintered oil-impregnated bearing equipped with such a bearing hole of a clearance structure; a manufacturing method, in which a sizing step is provided after a compression molding step to mold a bearing material composed of fine particles by compression, is proposed to manufacture the sintered oil-impregnated bearing. (For example, refer to Patent Document 1)

In the compression molding step of the method of manufacturing a sintered oil-impregnated bearing described in Patent Document 1; a small-diameter internal circumference section is formed at one end of a bearing hole so as to become a bearing surface, and a large-diameter internal circumference section is then formed, starting from the small-diameter internal circumference section toward the other end of the bearing hole. Incidentally, the outer diameter of the compression-molded piece molded by compression is almost uniform. Then, subsequently in a sizing step, the compression-molded piece is inserted into a metal mold having a size-reduction drawing part while the other end of the bearing hole having the large-diameter internal circumference section formed there is oriented toward the metal mold. Meanwhile, after a sizing core is inserted into the bearing hole, the compression-molded piece is pressed between the size-reduction drawing part and the sizing core to carry out diameter-reduction manufacturing so that another bearing surface is formed at the other end of the bearing hole. Then, a clearance surface section is formed between the bearing surfaces.

Patent Document 1

Kokoku (examined patent publication) No. 8-6124

c) Disclosure of the Invention

### PROBLEM TO BE SOLVED BY THE INVENTION

However, in the sintered oil-impregnated bearing manufactured by the manufacturing method described in Patent Document 1 mentioned above, no clear boundary is formed between the bearing surface formed at the other end of the bearing hole by the sizing step and the clearance surface. Therefore, the clearance surface to be created for the purpose of reduction of turning loss of the motor is actually not formed in an appropriate manner so that there is a chance of a problem that the turning loss of the motor may increase. Furthermore, since no clear boundary is formed between the bearing surface and the clearance surface, there is also a chance of another problem that the inner diameter accuracy of the bearing surface becomes deteriorated and/or the dimension accuracy of the effective length of the bearing surface worsens so as to vary the bearing performance.

Then, the problem to be solved in the present invention is to provide a sintered oil-impregnated bearing equipped with a bearing hole having a clearance structure, in which a clearer boundary is formed between the bearing surface and the clearance surface, and a manufacturing method thereof.

### MEANS TO SOLVE THE PROBLEM

To solve the problem identified above, the inventor of the present invention has made various examinations. In particular, a variety of examinations have been put into practice while focusing on the amount of a spring back that comes up on the sintered oil-impregnated bearing after the sizing step. As a result of the examinations, it has been concluded that the boundary is formed more clearly between the bearing surface and the clearance surface if the working order is changed in the sizing step regarding a step of inserting the sizing core into the bearing hole of the compression-molded piece and another step of diameter-reduction manufacturing for the external circumference of the sintered oil-impregnated bearing.

The present invention is based on the new knowledge described above; and in a cylindrical sintered oil-impregnated bearing, in which a bearing surface is formed at each of both ends in an axial direction, and a clearance surface section having its inner diameter enlarged is formed between both the bearing surfaces to provide a bearing hole thereof with a clearance structure; at least either of the bearing surfaces is formed by a sizing step for a compression-molded piece that is formed by a compression molding step, and in the sizing step, diameter-reduction manufacturing is carried out for at least either end of the compression-molded piece, and then afterward, a sizing core is inserted into the bearing hole of the compression-molded piece so as to eventually form the bearing surface.

Furthermore, in the present invention; in a method of manufacturing a cylindrical sintered oil-impregnated bearing, in which a bearing surface is formed at each of both ends in an axial direction, and a clearance surface section having its inner diameter enlarged is formed between both the bearing surfaces to provide a bearing hole thereof with a clearance structure; at least either of the bearing surfaces is formed by a sizing step for a compression-molded piece that is formed by a compression molding step, and in the sizing step, diameter-reduction manufacturing is carried out for at least either end of the compression-molded piece, and then afterward, a sizing core is inserted into the bearing hole of the compression-molded piece so as to eventually form the bearing surface.

In the present invention; at least either of the bearing surfaces is formed by a sizing step for a compression-molded piece that is formed by a compression molding step, and furthermore in the sizing step, diameter-reduction manufacturing is carried out for at least either end of the compression-molded piece, and then afterward, a sizing core is inserted into the bearing hole of the compression-molded piece so as to eventually form the bearing surface. Therefore, the bearing surface is formed by drawing operation using the sizing core. Consequently, being unaffected by the amount of a spring back that comes up after the sizing step, the boundary can be formed more clearly between the bearing surface and the clearance surface. As a result, it becomes possible to maintain the inner diameter accuracy and the dimension accuracy of the effective length of the bearing surface, and moreover to reduce turning loss of the motor as well.

Furthermore, since diameter-reduction manufacturing is carried out for at least either end of the compression-molded piece, and then subsequently a sizing core is inserted into the bearing hole of the compression-molded piece so as to eventually form the bearing surface; it becomes easy to adjust the size of porous structure (porous holes) to be formed at the bearing surfaces so that it becomes unnecessary to have any step to re-adjust the porous structure.

In the present invention, it is preferable that a sizing jig that consists of a stationary jig and a movable jig is used in the sizing step, and either of the stationary jig and movable jig is equipped with a guide pin to be inserted into a bearing hole of the compression-molded piece, a first punch to carry out the diameter-reduction manufacturing, and a second punch that is positioned between the guide pin and the first punch in a radial direction in order to adjust an axial-direction length of a diameter-reduced section formed by the diameter-reduction manufacturing. In this case, for example, the first punch is a stationary punch, and the second punch is a movable punch.

In the case where either of the stationary jig and movable jig of the sizing jig is equipped with the first punch to carry out the diameter-reduction manufacturing and the second punch to adjust the axial-direction length of the diameter-reduced section, the first punch and the second punch can be separated from each other and therefore it becomes easy to make a correction when any punch becomes worn out. Furthermore, since the manufacturing conditions for the diameter-reduced section can be set up by the guide pin, the first punch, and the second punch; the preparation time for the sizing jig can be shortened, and therefore controlling the sizing step can be simplified.

In the present invention; it is preferable that, in the sintered oil-impregnated bearing, a flange section with its diameter enlarged in a radial direction is formed at one end section in an axial direction; the movable jig is equipped with the guide pin, the first punch, and the second punch; and in the sizing step, the flange section is fixed to the stationary jig, while the diameter-reduced section is formed at the other end section where the flange section is not formed. In this case, the flange section is fixed to the stationary jig; and therefore, when the compression-molded piece is set onto the stationary jig, the setting position and the setting angle can become stable. Furthermore, the posture of the sintered oil-impregnated bearing in the sizing step becomes stable. Eventually, sizing operation for the sintered oil-impregnated bearing can be carried out with stability.

### ADVANTAGEOUS EFFECT OF THE INVENTION

As described above, in a sintered oil-impregnated bearing relating to the present invention; at least either of the bearing surfaces is formed by the sizing step for the compression-molded piece that is formed by the compression molding step, and in the sizing step, diameter-reduction manufacturing is carried out for at least either end of the compression-molded piece, and then afterward, the sizing core is inserted into the bearing hole of the compression-molded piece so as to eventually form the bearing surface. Furthermore, in a method of manufacturing a sintered oil-impregnated bearing relating to the present invention; at least either of the bearing surfaces is formed by the sizing step for the compression-molded piece that is formed by the compression molding step, and in the sizing step, diameter-reduction manufacturing is carried out for at least either end of the compression-molded piece, and then afterward, the sizing core is inserted into the bearing hole of the compression-molded piece so as to eventually form the bearing surface. Therefore, a boundary can be formed more clearly between the bearing surface and the clearance surface. As a result, it becomes possible to maintain the inner diameter accuracy and the dimension accuracy of the effective length of the bearing surface, and moreover to reduce turning loss of the motor as well.

### BRIEF DESCRIPTION OF THE DRAWINGS

In the drawings:

FIG. 1 is a cross-sectional side view drawing to show the structure of a motor, in which a sintered oil-impregnated bearing relating to an embodiment of the present invention is used;

FIG. 2A and FIG. 2B are a semi-cross-sectional side view drawing and a bottom view drawing, each of which shows a side view and a bottom view of a sintered oil-impregnated bearing relating to an embodiment of the present invention, respectively;

FIG. 3 is a diagrammatic illustration to generally show a compression molding step relating to an embodiment of the present invention;

FIG. 4 is a side view drawing to show a sizing jig relating to an embodiment of the present invention;

FIG. 5, including some side view drawings, illustrates a sizing step relating to an embodiment of the present invention; while FIG. 5A, FIG. 5B, FIG. 5C, and FIG. 5D illustrate a state of a guide pin inserted, a state of a diameter-reduced section at the time of diameter-reduction manufacturing, a state at the time of inserting a sizing core, and a state at the time of sizing core insertion completed, respectively;

FIG. 6, including a couple of drawings, generally illustrates a mold-forming step of bearing surfaces in the sizing step shown in FIG. 5; while FIG. 6A and FIG. 6B illustrate a diameter-reduction manufacturing step of a diameter-reduced section and a step of inserting a sizing core, respectively;

FIG. 7A and FIG. 7B are graphs to show actual measure values of bearing holes formed by a method of manufacturing a sintered oil-impregnated bearing relating to the embodiment of the present invention and a conventional method of manufacturing a sintered oil-impregnated bearing, respectively;

FIG. 8 is a semi-cross-sectional side view drawing to show a side view of a sintered oil-impregnated bearing relating to another embodiment of the present invention;

FIG. 9 shows sectional drawings to illustrate shapes of bearing surfaces of a sintered oil-impregnated bearing relating to another embodiment of the present invention; and

FIG. 10 is an outline side view drawing to generally show a sizing jig relating to another embodiment of the present invention;

### DESCRIPTION OF THE PREFERRED EMBODIMENTS

A preferred embodiment of the present invention is described below with reference to the accompanying drawings.

Construction of the Motor

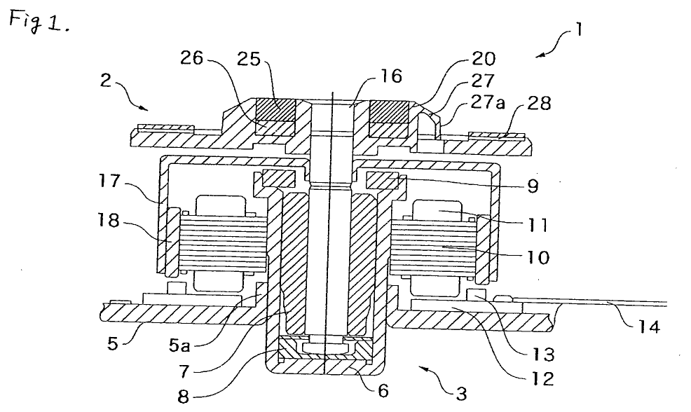

FIG. 1 is a cross-sectional side view drawing to show the structure of a motor, in which a sintered oil-impregnated bearing relating to an embodiment of the present invention is used.

A sintered oil-impregnated bearing of the present embodiment is a radial bearing 7 to be used for a motor 1 that drives an optical disc such as a CD, a DVD, and so forth. In FIG. 1, the motor 1 is composed of a turning element 2 including a rotary shaft 16, and a stator element 3 by which the turning element 2 is supported so as to be enabled to turn. Incidentally, the motor 1 of the embodiment is a high-speed turning motor with its rated operation speed at 10,000 rpm.

The stator element 3 is mainly composed of some key components, such as a plane base plate 5, a bearing holder 6 that is fixed to the base plate 5 and shaped like a cylinder with its bottom part, a radial bearing 7 as well as a thrust bearing 8, both of which are fixed and retained inside the bearing holder 6, a laminated core 10 fixed at the outer circumference of the bearing holder 6, and a driving coil 11 that is wound around a salient pole part placed at the outer circumference of the laminated core 10.

With the base plate 5, a bearing holder fixing part 5a is formed while it is raised upward as shown in the drawing, and the bearing holder 6 is fixed to the bearing holder fixing part 5a. Furthermore, on the base plate 5, a circuit board 12 for driving the motor 1 is placed. On the circuit board 12, a detection device 13 for detecting a turning position of the turning element 2 is placed, and a wiring board 14 is connected to the circuit board 12 with soldering.

The thrust bearing 8 to support the turning element 2 in the thrust direction and the radial bearing 7 to support the turning element 2 in the radial direction are press-fit in this due order into the internal circumference section of the bearing holder 6 so as to be fixed and retained there. The radial bearing 7 of the present embodiment is a fluid dynamic bearing. The detailed structure of the radial bearing 7 is described later.

The laminated core 10 is fixed to the outer circumference of the bearing holder 6, while being stuck down there. Furthermore, at the opening end of the bearing holder 6 (at the upper end on the drawing), an attracting magnet 9 that attracts a rotor hub 17 in the axial direction, to be described later, constituting the turning element 2 is fixed. The attracting magnet 9 and the rotor hub 17 eventually make the turning element 2 stabilized in the axial direction.

The turning element 2 is constructed by having; the rotary shaft 16 supported by the radial bearing 7 and the thrust bearing 8 so as to be enabled to turn; the rotor hub 17 that is fixed to the rotary shaft 16, shaped like a cylinder with its bottom part, and made of a magnetic material; a cylindrical driving magnet 18 fixed to the internal circumference section of the rotor hub 17; and a turntable 20 that is fixed at the top of the rotary shaft 16 for the purpose of mounting a data disc.

The rotor hub 17 and the turntable 20 are assembled onto the rotary shaft 16 in this due order from the bottom to the top on the drawing, and eventually the bottom of the rotor hub 17 and the attracting magnet 9 are laid out so as to become face to face in the axial direction. Furthermore, the driving magnet 18 is fixed to the internal circumference section of the rotor hub 17, while being stuck down there, in such a manner that the internal circumference of the driving magnet 18 is faced in the radial direction to the salient pole part placed at the laminated core 10, and moreover one end of the driving magnet 18 in the axial direction (at the lower end on the drawing) is faced in the axial direction to the detection device 13 placed on the circuit board 12.

The turntable 20, being formed with resin and shaped like a round disc, is equipped with; a chucking magnet 25 to which a clamper, not illustrated on the drawing, is chucked; a disc holding section 27 to hold a data disc; and a disc mounting surface 28 on which the data disc is mounted.

The chucking magnet 25 is fixed at an outer position in the radial direction away from a center hole 29 of the turntable 20 through a magnetic piece 26. Meanwhile, the disc holding section 27 is formed at a position outside in the radial direction next to the groove part where the chucking magnet 25 is fixed. Onto the disc holding section 27, a plurality of positioning elements 27a are placed at regular angular intervals in a circumferential direction, for locating a data disc by pressing outward the center hole of the data disc in the radial direction. Moreover, the disc mounting surface 28 is formed at a position further outside in the radial direction away from the disc holding section 27, being at an elevation somewhat lower than the top surface of the chucking magnet 25.

Construction of the Sintered Oil-Impregnated Bearing

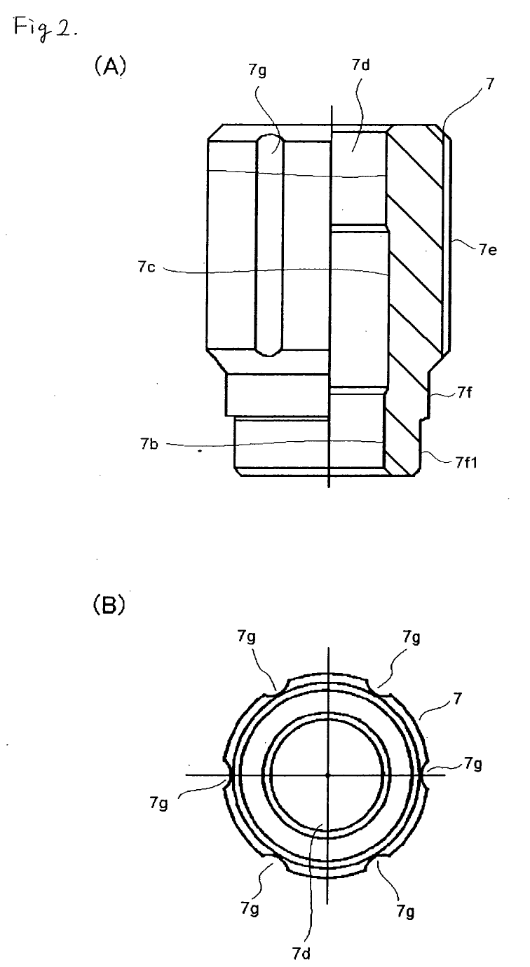

FIG. 2A and FIG. 2B are a semi-cross-sectional side view drawing and a bottom view drawing, each of which shows a side view and a bottom view of a sintered oil-impregnated bearing relating to an embodiment of the present invention, respectively.

In FIG. 2, a radial bearing 7 is a cylindrical sintered oil-impregnated bearing, in which a bearing surface 7a and another bearing surface 7b are formed at both ends of the bearing in the axial direction; while a clearance surface section 7c having its inner diameter enlarged is formed between both the bearing surfaces 7a and 7b to provide a bearing hole 7d thereof with a clearance structure. The radial bearing 7 is made of a Fe—Cu base bearing material; and practically to describe, it is formed with a bearing material whose composition is 30 to 70% of Fe, 10% or less of Sn, and the remaining portion of Cu. Furthermore, an area ratio of the porous structure to be formed at the bearing surfaces 7a and 7b is 10 to 40%.

The external section of the radial bearing 7 is composed of a large-diameter circumference 7e, a small-diameter circumference 7f that is smaller than the large-diameter circumference 7e in diameter, and a diameter-reduced section 7f1 made by diameter-reduction manufacturing on the small-diameter circumference 7f. The large-diameter circumference 7e and the small-diameter circumference 7f are formed by a compression molding step to be described later. Furthermore, the diameter-reduced section 7f1 is formed in a sizing step to be described later by diameter-reduction manufacturing on a part of the end section of the small-diameter circumference 7f (at the lower end on the drawing), which is positioned at the outer side of the bearing surface 7b in the radial direction. Then, the large-diameter circumference 7e, the small-diameter circumference 7f, and the diameter-reduced section 7f1 are laid out in this due order in the axial direction.

In the large-diameter circumference 7e, six vertical grooves 7g being elongated in the axial direction are laid out at regular angular intervals in a circumferential direction. The vertical grooves 7g have functions of easing press-fit force at the time of press-fitting the radial bearing 7 into the bearing holder 6, as well as draining air at the time of press-fitting.

Manufacturing Method of the Sintered Oil-Impregnated Bearing

A method of manufacturing the radial bearing 7 constructed as described above is explained below:

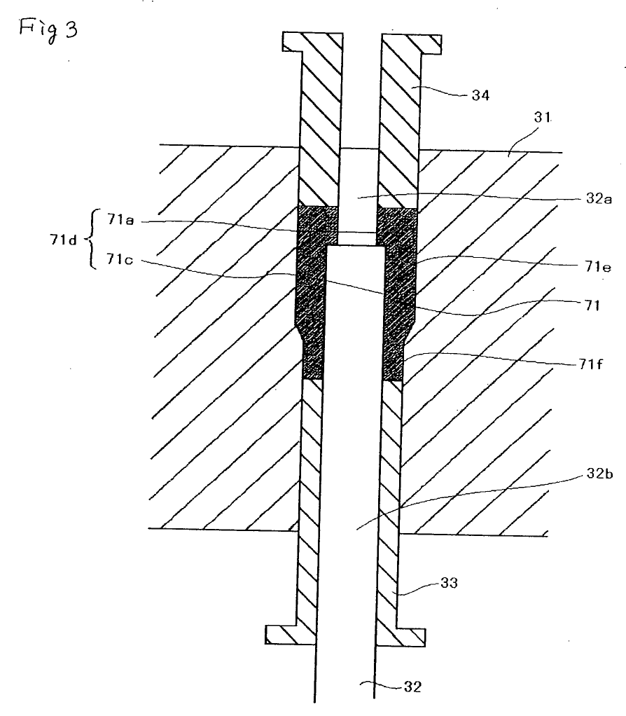

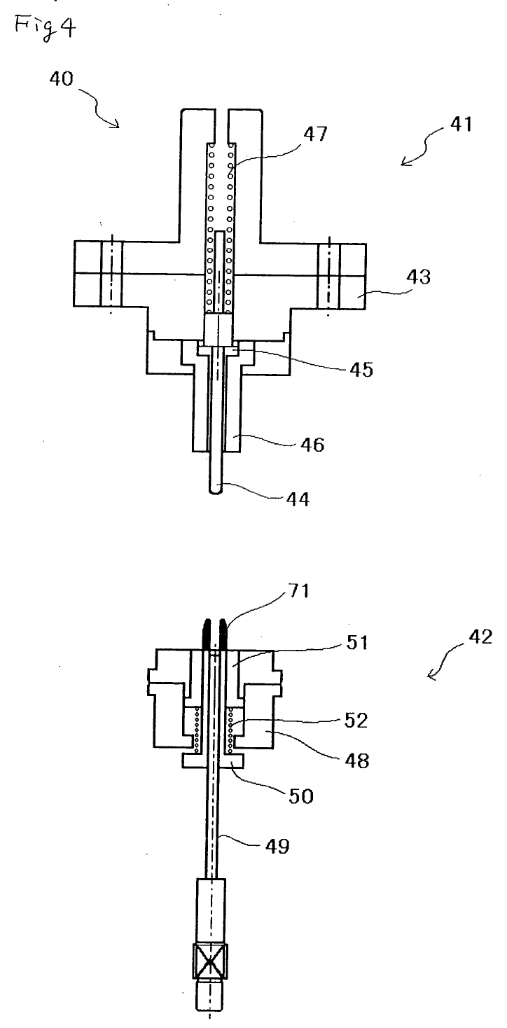

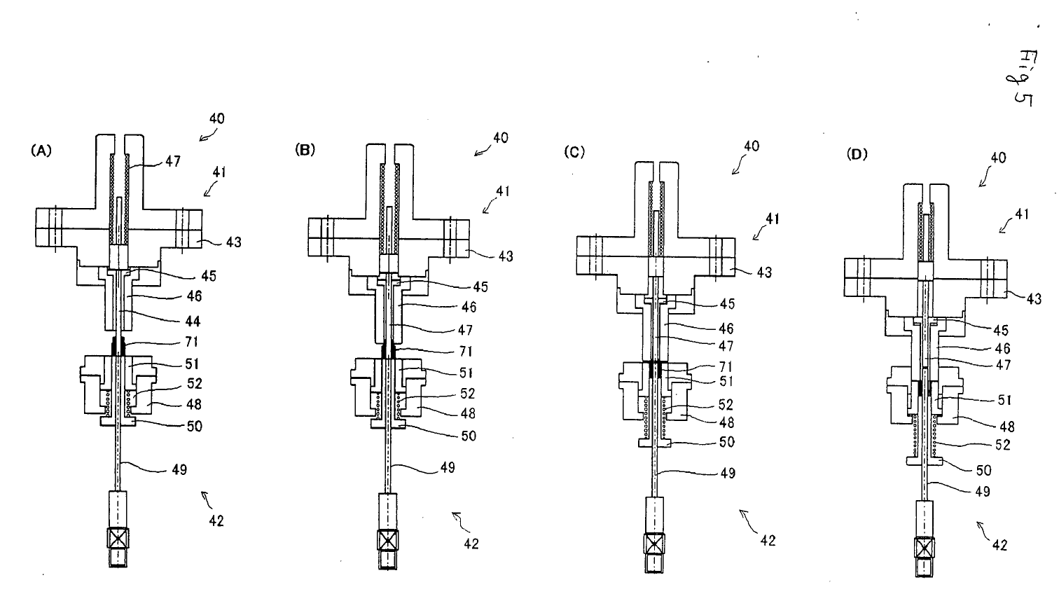

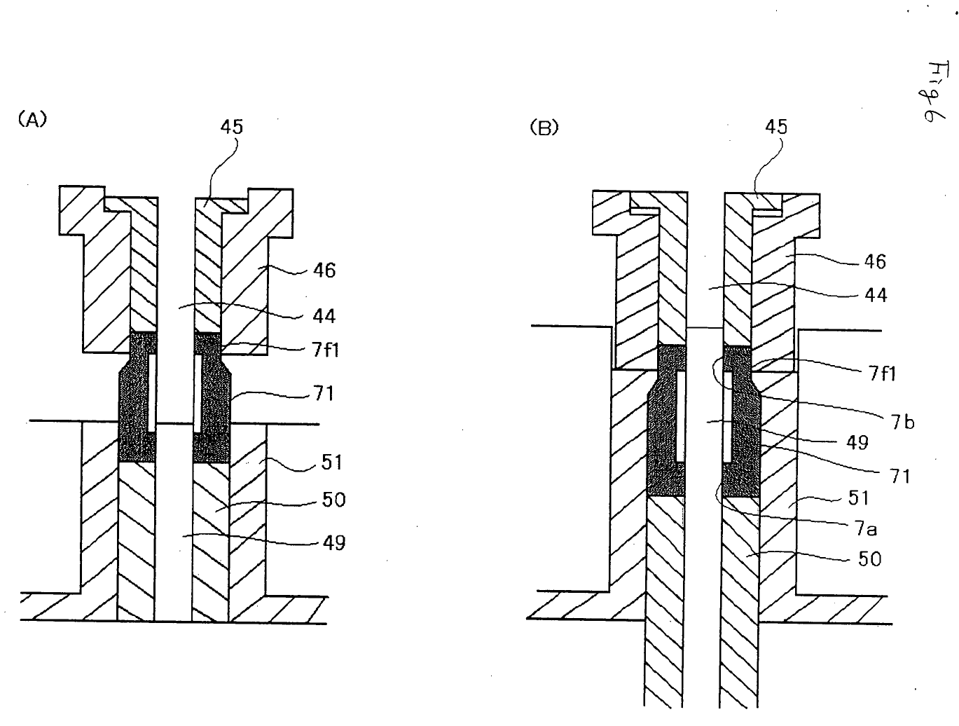

FIG. 3 is a diagrammatic illustration to generally show a compression molding step relating to an embodiment of the present invention. FIG. 4 is a side view drawing to show a sizing jig relating to an embodiment of the present invention. FIG. 5, including some side view drawings, illustrates a sizing step relating to an embodiment of the present invention; while FIG. 5A, FIG. 5B, FIG. 5C, and FIG. 5D illustrate a state of a guide pin inserted, a state of a diameter-reduced section at the time of diameter-reduction manufacturing, a state at the time of inserting a sizing core, and a state at the time of sizing core insertion completed, respectively. FIG. 6, including a couple of drawings, generally illustrates a mold-forming step of bearing surfaces in the sizing step shown in FIG. 5; while FIG. 6A and FIG. 6B illustrate a diameter-reduction manufacturing step of a diameter-reduced section and a step of inserting a sizing core, respectively.

The radial bearing 7 is formed through a sintering process. Steps of the sintering process include a bearing material charging step, a compression molding step, a thermal treatment step, a sizing step, a washing step, and an oil impregnation step; and then practically the sintering process for the radial bearing 7 is carried out in this due order. The following sections describe an embodiment of the compression molding step and the sizing step that are peculiar elements of the composition of the present invention. As far as any other steps are concerned, well-known step composition can be adopted for them, and therefore, explanation on those other steps is just omitted in the following sections.

As FIG. 3 shows, a bearing material charged into a cavity of a die 31 in the bearing material charging step is compression-molded with a core 32, which is equipped with a small-diameter portion 32a and a large-diameter portion 32b, a lower punch 33, and an upper punch 34 in the compression molding step. A compression-molded piece 71 formed by compression is provided with an internal circumference having a bearing hole 71d composed of a small-diameter inner circumference 71a and a large-diameter inner circumference 71c, and the small-diameter inner circumference 71a is positioned at the upper side on the drawing, while the large-diameter inner circumference 71c is laid out at the lower side on the drawing. Furthermore, the external circumference of the compression-molded piece 71 is composed of a large-diameter outer circumference 71e and a small-diameter outer circumference 71f, and the large-diameter outer circumference 71e is positioned at the upper side on the drawing, while the small-diameter outer circumference 71f is laid out at the lower side on the drawing. Then, the large-diameter outer circumference 71e becomes the large-diameter circumference 7e of the radial bearing 7, as it is. Meanwhile, the small-diameter outer circumference 71f becomes the small-diameter circumference 7f of the radial bearing 7, and the diameter-reduced section 7f1 to be formed by diameter-reduction manufacturing in the sizing step.

In the sizing step, a sizing jig 40 that consists of a movable jig 41 and a stationary jig 42 is used, as FIG. 4 shows. In the sizing jig 40; the stationary jig 42, on which the compression-molded piece 71 is placed, is positioned at a lower side while the movable jig 41 is able to move vertically in relation to the stationary jig 42.

The movable jig 41 is equipped with a base part 43, a guide pin 44 to be inserted into the bearing hole 71d of the compression-molded piece 71, an upper stationary punch 46 that carries out diameter-reduction manufacturing for the diameter-reduced section 7f1, and an upper movable punch 45 that is positioned between the guide pin 44 and the upper stationary punch 46 in the radial direction in order to adjust the axial-direction length of the diameter-reduced section 7f1.

The upper stationary punch 46 is shaped to be cylindrical, being provided with a shoulder part that is fixed to the base part 43. The upper movable punch 45 is shaped to be cylindrical, being provided with a shoulder part; and it is supported along the internal circumference of the upper stationary punch 46 that exists, being elongated in the vertical direction on the drawing, so as to be enabled to slide vertically in relation to the upper stationary punch 46. Moreover, the upper movable punch 45 is pressed in the downward direction on the drawing in relation to the upper stationary punch 46, by pressing measures whose illustration is omitted on the drawing. The guide pin 46 is shaped like a long round bar, and it is supported along the internal circumference of the upper movable punch 45 that exists, being elongated in the vertical direction on the drawing, so as to be enabled to slide vertically in relation to the upper stationary punch 46 and the upper movable punch 45. Furthermore, the guide pin 46 is pressed in the downward direction on the drawing by a compression coil spring 47 fixed to the base part 43.

The stationary jig 42 is equipped with a stationary base portion 48, a sizing core 49 shaped like a long round bar that is fixed together with the stationary base portion 48, a first lower movable punch 50 shaped to be cylindrical and supported so as to be enabled to vertically slide along an external circumference of a sizing core 49, and a second lower movable punch 51 shaped to be cylindrical and supported so as to be enabled to vertically slide along the external circumference of the first lower movable punch 50. The outer diameter of the sizing core 49 is somewhat greater than the outer diameter of the guide pin 44 and the inner diameter of the small-diameter inner circumference 71a of the compression-molded piece 71. Concretely to describe, the outer diameter of the sizing core 49 is approximately 50 microns greater than the outer diameter of the guide pin 44 and the inner diameter of the small-diameter inner circumference 71a of the compression-molded piece 71. Furthermore, both the first lower movable punch 50 and second lower movable punch 51 are each equipped with a shoulder part at their lower end shown on the drawing, and each of top and bottom ends of a tension coil spring 52 is connected to both the shoulder parts individually. Moreover, the second lower movable punch 51 is pressed in the upward direction on the drawing in relation to the base portion 48 by a pressing component whose illustration is omitted on the drawing. Then, the compression-molded piece 71 is placed onto the upper end of the first lower movable punch 50 shown on the drawing.

The sizing step is carried out by using the sizing jig 40 structured as described above. In the sizing step; as shown in FIG. 5, the movable jig 41 gets lowered at first in relation to the stationary jig 42 where the compression-molded piece 71 is placed onto the upper end of the first lower movable punch 50 shown on the drawing in such a manner that the end of the side of the small-diameter outer circumference 71f (namely; the side of the large-diameter inner circumference 71c) is faced in the upward direction on the drawing, so that the guide pin 44 is inserted into the bearing hole 71d of the compression-molded piece 71 (FIG. 5A).

Then, the movable jig 41 further gets lowered to carry out diameter-reduction manufacturing for the diameter-reduced section 7f1 (FIG. 5B). More concretely to describe; as FIG. 6A shows, the upper stationary punch 46 carries out diameter-reduction manufacturing on the small-diameter outer circumference 71f. On this occasion, the internal circumference of the diameter-reduced section 7f1 is retained in its radial direction by the guide pin 44. Furthermore, the upper end of the compression-molded piece 71 shown on the drawing contacts the lower end of the upper movable punch 45, and the axial-direction length of the diameter-reduced section 7f1 is adjusted by the upper movable punch 45. Meanwhile, the first lower movable punch 50 receives a stress from the upper movable punch 45 so as to move downward together with the compression-molded piece 71 in relation to the second lower movable punch 51. On this occasion, the compression-molded piece 71 gets compressed by the upper movable punch 45 and the first lower movable punch 50.

Subsequently, still further the movable jig 41 gets lowered, and then the sizing core 49 is inserted into the bearing hole 71d of the compression-molded piece 71 (FIG. 5C). More concretely to describe; as FIG. 6B shows, the first lower movable punch 50 receives a stress from the upper movable punch 45 so as to move downward together with the compression-molded piece 71 in relation to the second lower movable punch 51, and eventually the compression-molded piece 71 gets compressed by the upper movable punch 45 and the first lower movable punch 50. Meanwhile, the lower end of the upper stationary punch 46 contacts the upper end of the second lower movable punch 51 so that the second lower movable punch 51 moves downward in relation to the base portion 48.

When the sizing core is inserted into the bearing hole 71d of the compression-molded piece 71, the bearing surfaces 7a and 7b are formed at the internal circumference of the small-diameter inner circumference 71a and the internal circumference of the diameter-reduced section 7f1 at its end side, respectively, by the sizing core 49 since the outer diameter of the sizing core 49 is somewhat greater than the outer diameter of the guide pin 44 and the inner diameter of the small-diameter inner circumference 71a of the compression-molded piece 71. At this time, the bearing surfaces 7a and 7b are squeezed, and the size of porous structure to be formed at the bearing surfaces 7a and 7b is adjusted.

Subsequently; when the movable jig 41 gets lowered still further, insertion of the sizing core 49 into the bearing hole 71d of the compression-molded piece 71 as well as compressing operation for the compression-molded piece 71 get completed to accomplish the sizing step. Subsequently, after a washing step and an oil impregnation step, manufacturing the radial bearing 7 gets completed.

### Principal Effect of the Embodiment

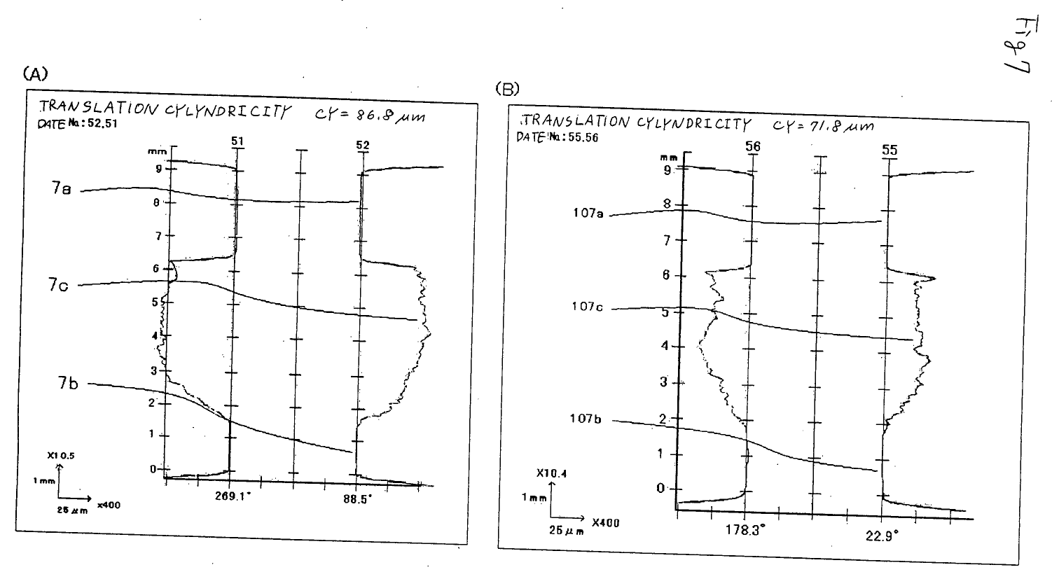

As described above; in the present embodiment, the bearing surfaces 7a and 7b are formed through the sizing step working on the compression-molded piece 71 formed by the compression molding step. In particular, the bearing surface 7b is formed by insertion of the sizing core 49 into the bearing hole 71d of the compression-molded piece 71 in the sizing step; after diameter-reduction manufacturing is carried out for the external circumference of the radial bearing 7, which is located at the external position outside the bearing surface 7b in the radial direction, so as to form the diameter-reduced section 7f1 there. As a result, the bearing surfaces 7a and 7b are formed by squeezing with the sizing core 49. Consequently, it is possible to form a boundary more clearly between the bearing surface 7b and the clearance surface 7c, without being affected by the amount of a spring back that comes up after the sizing step. Contents of this effect are explained below with reference to FIG. 7.

FIG. 7A and FIG. 7B are graphs to show actual measure values of bearing holes formed by a method of manufacturing a sintered oil-impregnated bearing relating to the embodiment of the present invention and a conventional method of manufacturing a sintered oil-impregnated bearing, respectively.

As FIG. 7A and FIG. 7B definitely show; being compared with a clearance surface 107c formed by a conventional manufacturing method in which diameter-reduction manufacturing is carried out while a sizing core being inserted, the clearance surface 7c formed by a manufacturing method relating to the embodiment of the present invention is formed with more depth in relation to the bearing surfaces 7a and 7b (so as to make the inner diameter greater). Furthermore; being compared with an incline at a boarder section between a bearing surface 107b and the clearance surface 107c formed by the conventional manufacturing method, an incline at a boarder section between the bearing surface 7b and the clearance surface 7c formed by the manufacturing method relating to the embodiment of the present invention is made to be steeper. Namely, it proves that, being compared with the boarder section between the bearing surface 107b and the clearance surface 107c, the boarder section between the bearing surface 7b and the clearance surface 7c is formed more clearly. Therefore, in the case of the radial bearing 7 formed by the manufacturing method of the present embodiment, it is possible to maintain the inner diameter accuracy and the dimension accuracy of the effective length of the bearing surface 7b, and moreover the clearance surface 7c can be formed more clearly, so as to reduce turning loss of the motor 1 as well.

Furthermore, since the sizing core 49 is inserted into the bearing hole 71d of the compression-molded piece 71 after diameter-reduction manufacturing so as to eventually form the bearing surface 7b, it becomes easy to adjust the size of porous structure to be formed at the bearing surface 7b so that it becomes unnecessary to have any step to re-adjust the porous structure.

In the sizing step of the present embodiment, the sizing jig 40 that consists of the stationary jig 42 and the movable jig 41 is used, and the movable jig 41 is equipped with the guide pin 44 to be inserted into the bearing hole 71d of the compression-molded piece 71, the upper stationary punch 46 that carries out diameter-reduction manufacturing for the diameter-reduced section 7f1, and the upper movable punch 45 to adjust the axial-direction length of the diameter-reduced section 7f1. In other words, the upper stationary punch 46 and the upper movable punch 45 can be separated from each other. Therefore, it is possible to make a correction for each of the punches when the upper stationary punch 46 and/or the upper movable punch 45 become worn out, and making such a correction for the punches becomes easy. Furthermore, since the manufacturing conditions for the diameter-reduced section 7f1 can be set up by the guide pin 44, the upper stationary punch 46, and the upper movable punch 45; the preparation time for the sizing jig 40 can be shortened, and therefore controlling the sizing step can be simplified.

### Other Embodiments

The embodiment described above is an example of a preferred embodiment of the present invention, but it does not confine any other possible embodiment and various modifications can be implemented as far as they do not change the substantial concept of the present invention.

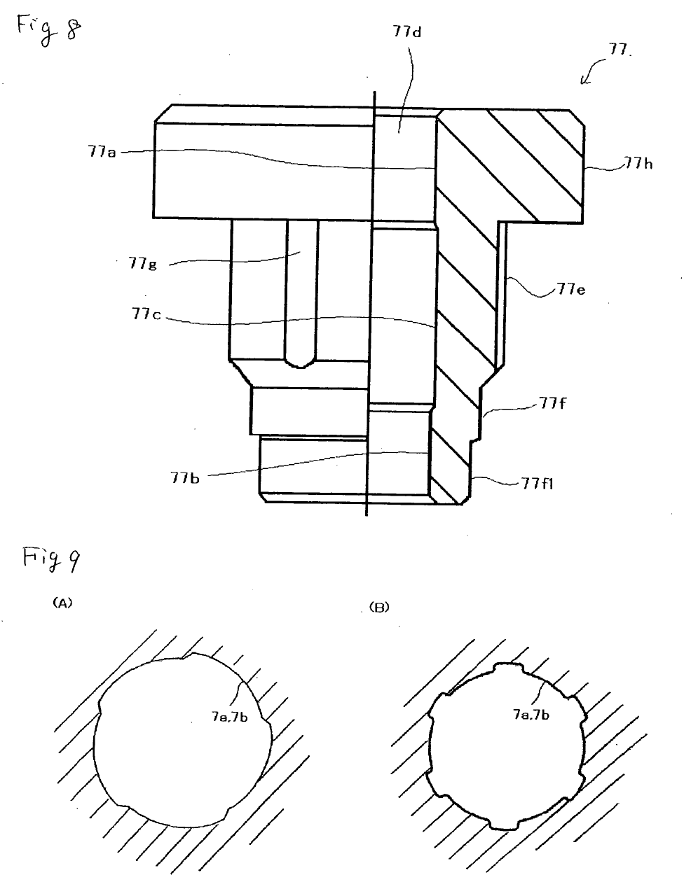

For example, as shown in FIG. 8; the method of manufacturing a sintered oil-impregnated bearing relating to the present invention can be adopted for a radial bearing equipped with flange 77, in which a flange section 77h having an enlarged diameter is formed at one end in the axial direction. In the case of the radial bearing equipped with flange 77; since the flange section 77h is mounted onto the upper end of the first lower movable punch 50, the setting position and the setting angle of the compression-molded piece 71 onto the first lower movable punch 50 as well as the posture of the radial bearing 77 in the sizing step become stable. Therefore, sizing operation for the radial bearing 77 can be carried out with stability. Incidentally; a bearing surface 77a, another bearing surface 77b, a clearance surface 77c, a bearing hole 77d, a large-diameter section 77e, a small-diameter section 77f, a diameter-reduced section 77f1, and a vertical groove 77g of the radial bearing 77 each correspond to the bearing surface 7a, the bearing surface 7b, the clearance surface 7c, the bearing hole 7d, the large-diameter circumference 7e, the small-diameter circumference 7f, the diameter-reduced section 7f1, and the vertical groove 7g of the radial bearing 7 shown by FIG. 2., respectively. The radial bearing equipped with flange 77 shown by FIG. 8 is used in a motor for audio equipment, and so on.

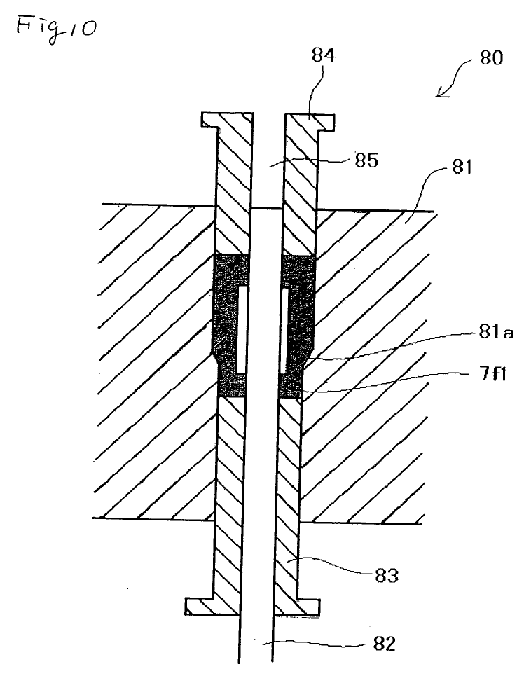

Furthermore, in the bearing surfaces 7a and 7b; tapered concave sections may be formed, as FIG. 9A shows; or even concave sections shaped like stepped grooves may be formed there, as FIG. 9B shows. Moreover, in the bearing surfaces 7a and 7b; grooves for the purpose of generating fluid dynamic pressure, such as herringbone-shaped ones and so on, may be formed as well.

Furthermore, a sizing jig is not confined to the sizing jig 40 shown by FIG. 4, and it is possible to use various other types of sizing jigs. For example, a sizing jig 80 including; a stationary metal mold 81 equipped with a diameter-reducing section 81a, a sizing core 82, a lower movable punch 83, an upper movable punch 84, and a guide pin85, as FIG. 10 shows; can be used. In this case, the compression-molded piece 71 molded through the compression molding step is inserted into the stationary metal mold 81 while the end section of the side of the small-diameter outer circumference 71f is oriented toward the stationary metal mold; and then, the upper movable punch 84 gets lowered to compress the compression-molded piece 71, and meanwhile the diameter-reduced section 7f1 is formed at first. Afterward, the sizing core 82 is inserted into the bearing hole 71d of the compression-molded piece 71, and then the sizing step gets completed.

Furthermore, it is also possible to use a sizing jig that is built up by combination of the movable jig 41 shown by FIG. 4, and the stationary metal mold 81, the sizing core 82, and the lower movable punch 83, all of which are shown by FIG. 10. In this case; the compression molding step carries out its forming operation in such a manner that the internal circumference of the compression-molded piece is composed of only a large-diameter inner circumference, and then, a diameter-reduced section is formed in the sizing step at each of both the end sections of the radial bearing in the axial direction. Since the sizing core 82 is inserted after the diameter-reduced sections are formed, it is possible to obtain the same effect as the above-described case, where the sizing jig 40 is used, results in.

It is also possible to use a sizing jig that can be materialized by turning the sizing jig 40, shown by FIG. 3, upside down or by turning the sizing jig 80, shown by FIG. 10, upside down.

While the foregoing description and drawings represent the present invention, it will be obvious to those skilled in the art that various changes may be made therein without departing from the true spirit and scope of the present invention.

### REFERENCE NUMERALS

7. radial bearing (sintered oil-impregnated bearing)
7a & 7b. bearing surface
7c. clearance surface
7d. bearing hole
7f1. diameter-reduced section
40. sizing jig
41. movable jig
42. stationary jig
44. guide pin
45. upper movable punch (second punch)
46. upper stationary punch (first punch)
49. sizing core
71. compression-molded piece
71d. bearing hole
77. radial bearing (sintered oil-impregnated bearing)
77a & 77b. bearing surface
77c. clearance surface
77d. bearing hole
77f1. diameter-reduced section
77h. flange section

What is claimed is:

1. A sintered oil-impregnated bearing comprising:
a cylindrical sintered oil-impregnated bearing, a bearing surface being formed at each of both ends in an axial direction, and a clearance surface section having its inner diameter enlarged being formed between both the bearing surfaces to provide a bearing hole thereof with a clearance structure;
at least either of the bearing surfaces being formed by a sizing step for a compression-molded piece that is formed by a compression molding step; and
in said sizing step, diameter-reduction manufacturing is carried out for at least either end of the compression-molded piece, and then afterward, a sizing core is inserted into the bearing hole of the compression-molded piece so as to eventually form the bearing surface.

2. A method of manufacturing a sintered oil-impregnated bearing comprising:
manufacturing a cylindrical sintered oil-impregnated bearing, in which a bearing surface is formed at each of both ends in an axial direction, and a clearance surface section having its inner diameter enlarged is formed between both the bearing surfaces to provide a bearing hole thereof with a clearance structure;
forming at least either of the bearing surfaces by a sizing step for a compression-molded piece that is formed by a compression molding step; and
in said sizing step, carrying out diameter-reduction manufacturing for at least either end of the compression-molded piece, and then afterward, inserting a sizing core into the bearing hole of the compression-molded piece so as to eventually form the bearing surface.

3. The method of manufacturing a sintered oil-impregnated bearing according to claim 2, wherein:
a sizing jig that consists of a stationary jig and a movable jig is used in the sizing step; and
either of the stationary jig and movable jig is equipped with a guide pin to be inserted into a bearing hole of the compression-molded piece, a first punch to carry out the diameter-reduction manufacturing, and a second punch that is positioned between the guide pin and the first punch in a radial direction in order to adjust an axial-direction length of a diameter-reduced section formed by the diameter-reduction manufacturing.

4. The method of manufacturing a sintered oil-impregnated bearing according to claim 3, wherein:
in the sintered oil-impregnated bearing, a flange section with its diameter enlarged in a radial direction is formed at one end section in an axial direction;
the movable jig is equipped with the guide pin, the first punch, and the second punch; and
in the sizing step, the flange section is fixed to the stationary jig, while the diameter-reduced section is formed at the other end section where the flange section is not formed.
